(19) United States
(12) Patent Application Publication
(10) Pub. No.: US 2015/0174814 A1
(43) Pub. Date: Jun. 25, 2015

(54) Device For Thermoforming Plastic Plates

(71) Applicant: COMI S.p.A., Ciserano (BG) (IT)

(72) Inventor: Simone SERTORI, Ciserano (IT)

(21) Appl. No.: 14/559,417

(22) Filed: Dec. 3, 2014

(30) Foreign Application Priority Data
Dec. 20, 2013 (IT) BO2013A 000700

(51) Int. Cl. B29C 51/18

(52) U.S. Cl. CPC B29C 51/18; B29L 2031/7404

(57) ABSTRACT

A device for thermo forming plates has a bell (3), an upper first frame with a lock for fixing to an upper first framework abutting on the bell with a seal therebetween. A second frame supports a forming mold. Vertical columns each have a top end fixed to the first frame and a lower end provided with a first connector lockable to a corresponding second connector fixed to the second frame. Each first connector has shoulders (20, 21) located at a predetermined mutual distance. Each second connector has at least one bolt, provided with a matching downward facing surface (26, 27). Each bolt is shifted by an actuator for alternatively matching with a respective shoulder. The matching surfaces (26, 27) are spaced apart by a distance equal to the predetermined mutual distance between the shoulders, increased or decreased to accommodate setting lengths between the first and second frames.

### CROSS REFERENCE TO RELATED APPLICATIONS

This application claims priority in Italian Patent Application no. 302013A 000700 filed 20 Dec. 2013, the contents of which are incorporated herein by reference.

### TECHNICAL FIELD

The present invention refers to the field concerning devices for vacuum thermoforming in an inner mold and for overpressure thermoforming in an outer mold plates made from a thermoplastic material and in particular refers to a device for the thermoforming of plastic plates with an adjustment capability for compensating for differences in thickness of the materials, equipment, tolerances and irregularities, and additionally having a pneumatic seal.

### BACKGROUND

There are known devices for forming thermoplastic sheets which include an upper part equipped with a bell in which pressure can be brought to negative values by suction means. Such a bell is supported by an upper frame with removable locks for attachment of an upper framework, lying on a horizontal plane, which abuts with a lower opening of the bell. A pneumatic air tight seal prevents leakage between the mouth of the bell and the top frame. Such known devices also include a lower framework placed horizontally under the upper one which reproduces the shape in plan, with the lower framework being connectable by removable lock means to a frame vertically movable by the action of respective actuators. A conveyor, for example of the chain type, transports the plasticized plates between the upper and lower frameworks such that by mutually approaching, these can tighten the plate.

A lower frame, placed below the upper one and the frameworks, supports a mold for forming the plate. The upper frame bears closing means, for example consisting of vertical column shaped stems whose free ends bear respective first connecting means for engaging corresponding second connecting means rigidly fixed to the second frame. The second connecting means of the second frame allow locking or release of the first connecting means and so then allow release of the upper and lower frames, for example to allow changing the tooling. Suitable actuators for the vertical translation of the closing means allow for the mutual approach and separation of the two upper and lower frames, according to the operation cycle of such known devices.

One drawback of the known devices is that the closing means are not able to ensure a tight seal between the abuting surfaces and maintaining a seal in all operating conditions and with all the different materials. In fact, the use of upper and lower frames equipped with equipment out of tolerance because of wear, use of plates with different thicknesses, tolerances and/or positioning inaccuracy of the parts can compromise the sealing and/or prevant a correct abutment.

### SUMMARY OF THE INVENTION

One object of the present invention is to propose a device able to locate the upper and lower frames at two or more predefined and predetermined mutual distances.

Another object is to propose a device that ensures the pneumatic sealing of the bell mouth via a seal able to compensate for the variations or irregularities of the distance of the bell mouth, in a dynamic way, and to adapt to the intense forces and stresses to which it is subjected.

### BRIEF DESCRIPTION OF THE DRAWINGS

The characteristics of the invention are highlighted in the following with particular reference to the accompanying drawings in which:

FIG. 1 shows a front view of a device for thermoforming plastic plates, the object of the present invention, when in a non-operating condition for the exchange of equipment;

FIG. 2 shows a front view of the device of FIG. 1 in a working condition with a standard thickness;

FIG. 3 shows an enlarged view, partially sectioned by a vertical plane of a portion of the device of FIG. 2;

FIG. 4 shows a front view of the device of FIG. 1 in a condition for working with an increased thickness of 4 mm compared to the standard thickness;

FIG. 5 shows an enlarged and partially sectioned view taken along a vertical plane of the device portion of FIG. 4;

FIG. 6 shows a front view of the device of FIG. 1 in a working condition consisting in the balloon formation of a plasticized plate which allows mold insertion from below to upwards;

FIG. 7 shows a partial view taken from below of the upper portion of the device of FIG. 1;

FIG. 8 shows an enlarged and partially sectioned view taken along a vertical plane of a portion of the device of FIG. 6;

FIG. 9 shows a partial and sectional view taken along the plane IX-IX of FIG. 7.

### DETAILED DESCRIPTION OF THE INVENTION

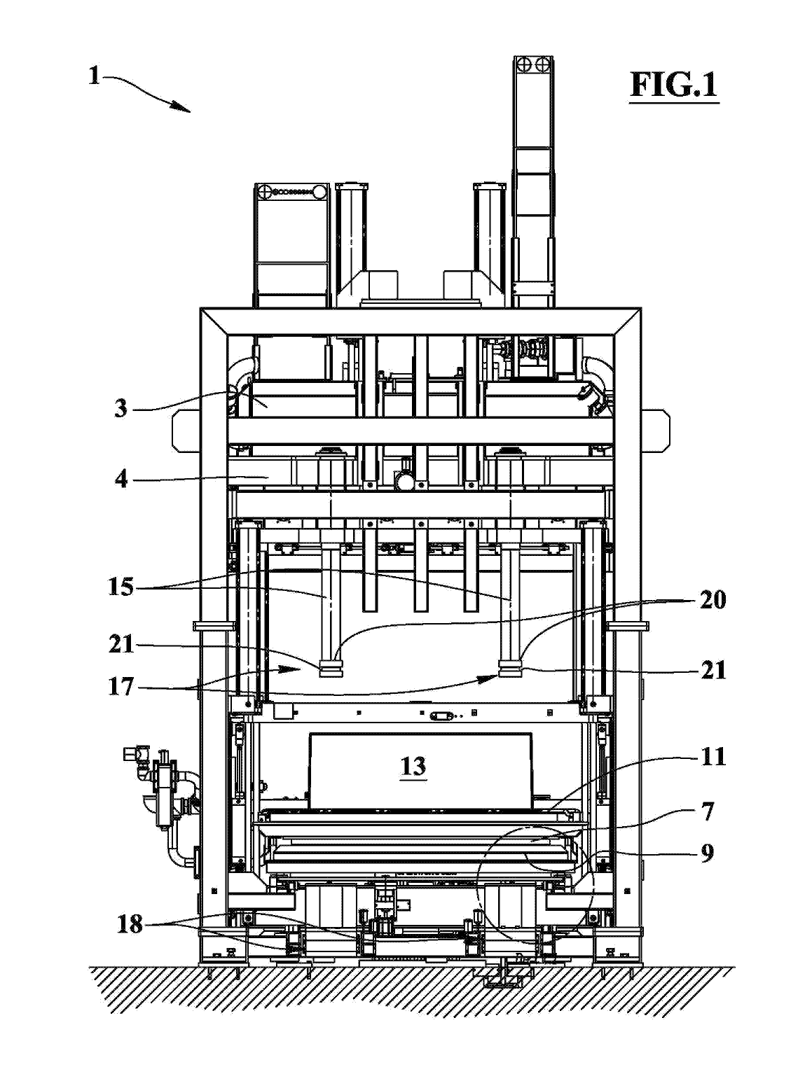

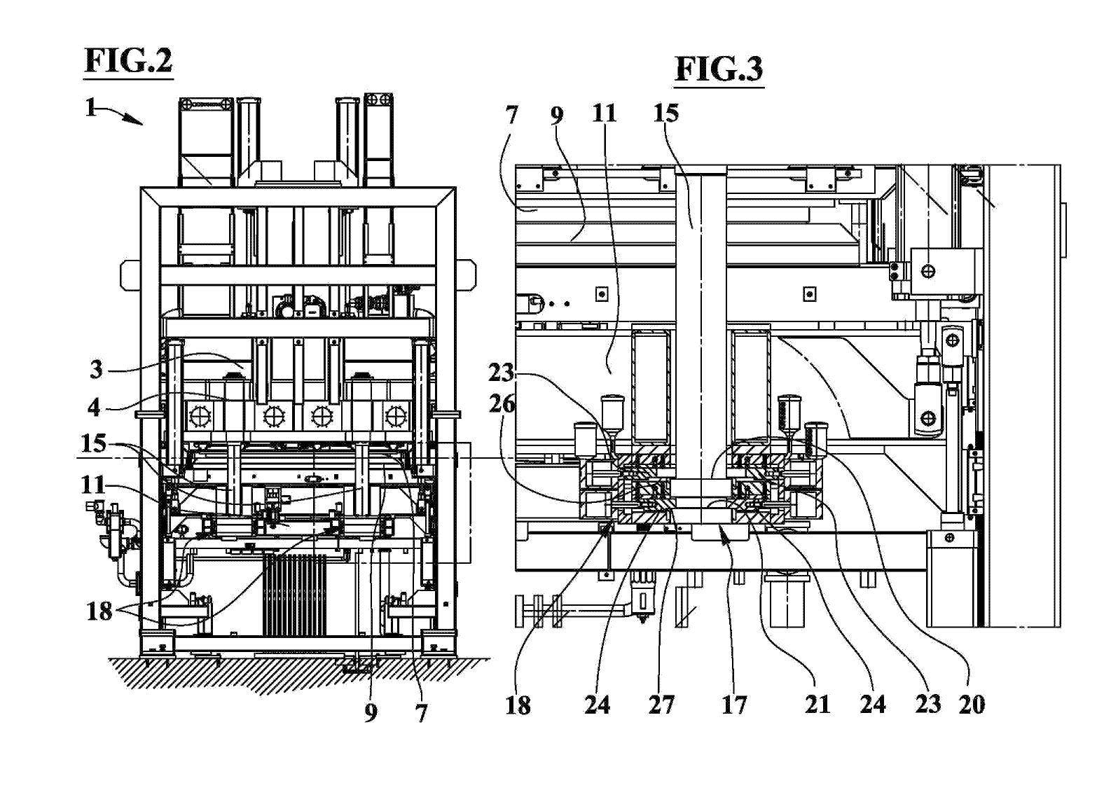

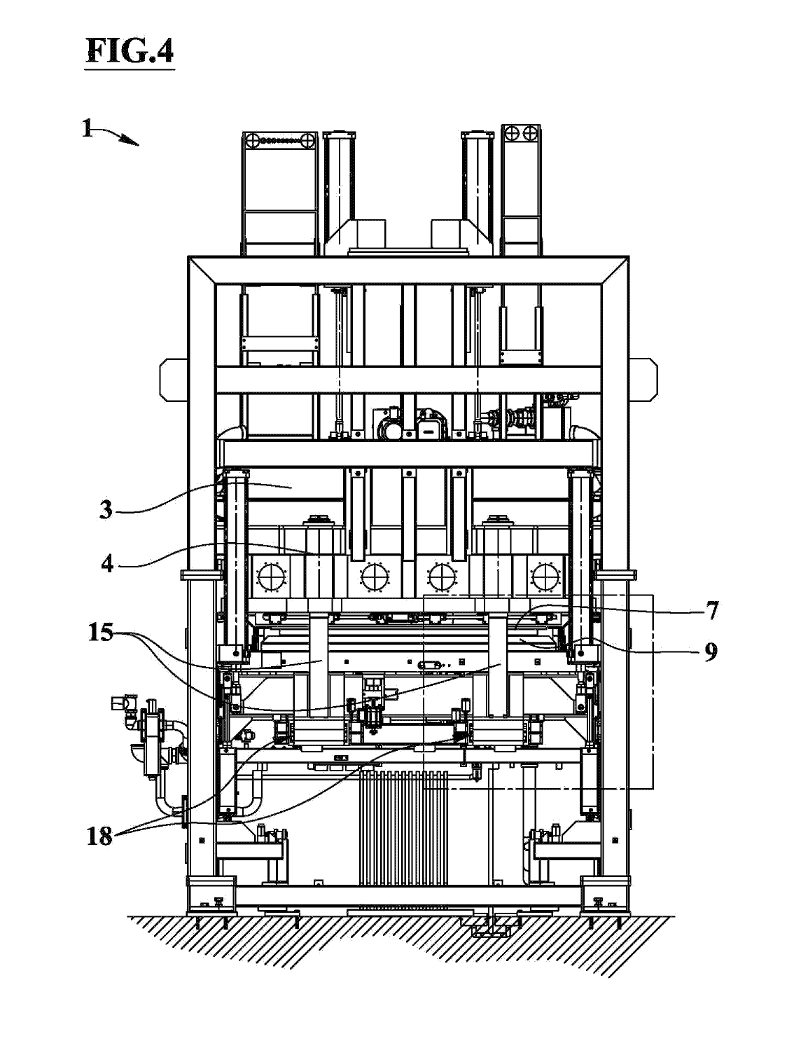

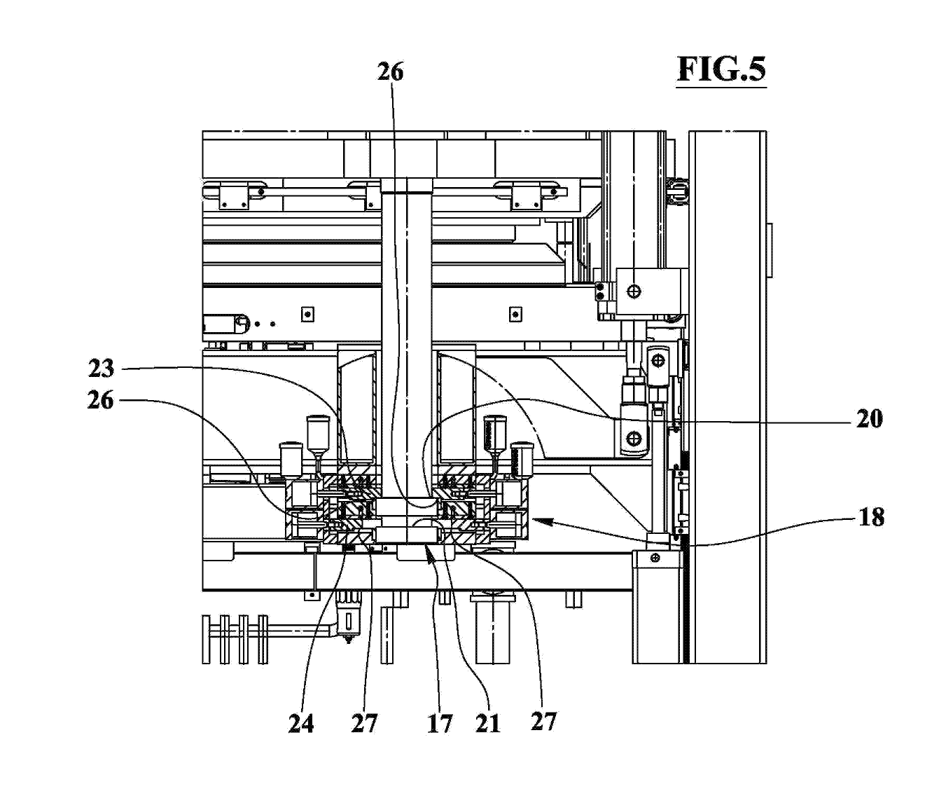

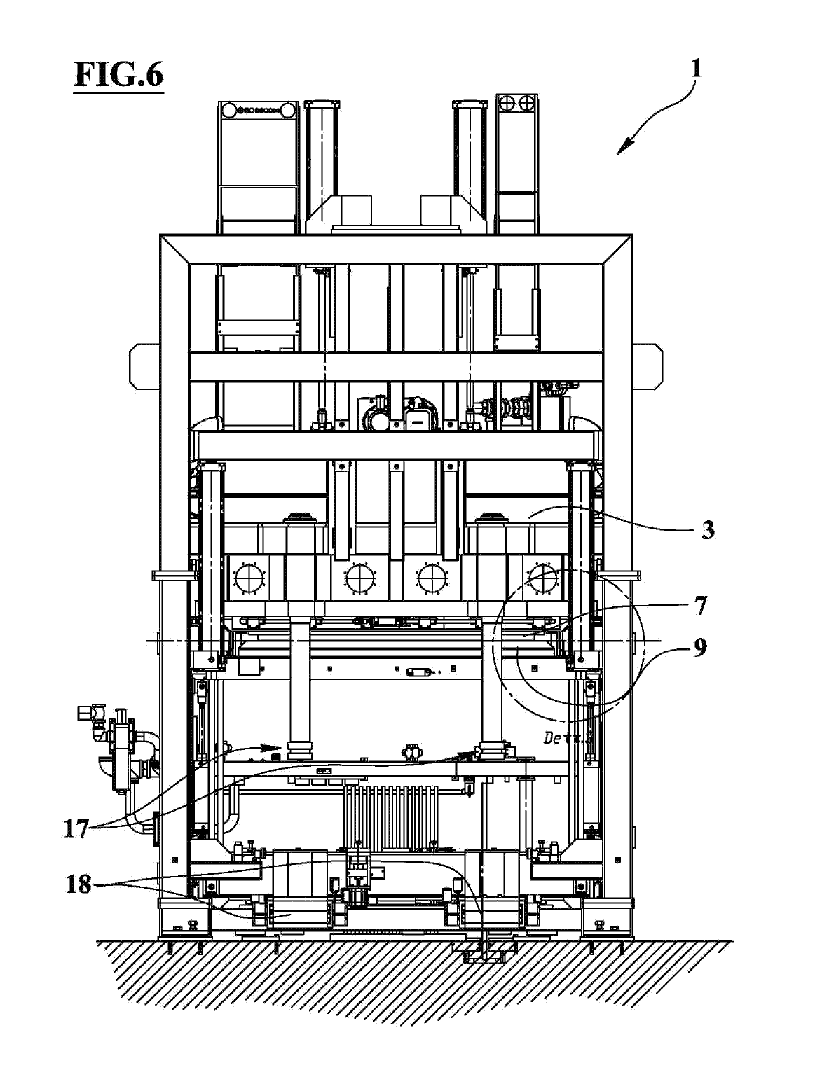

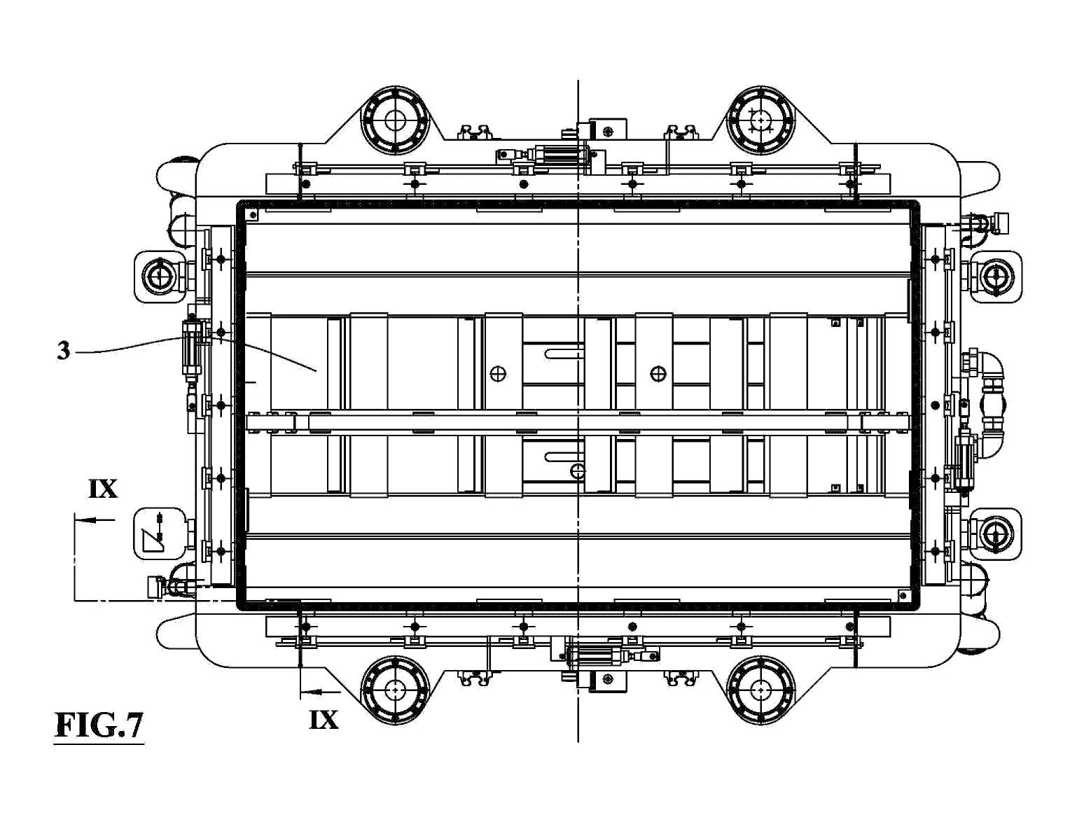

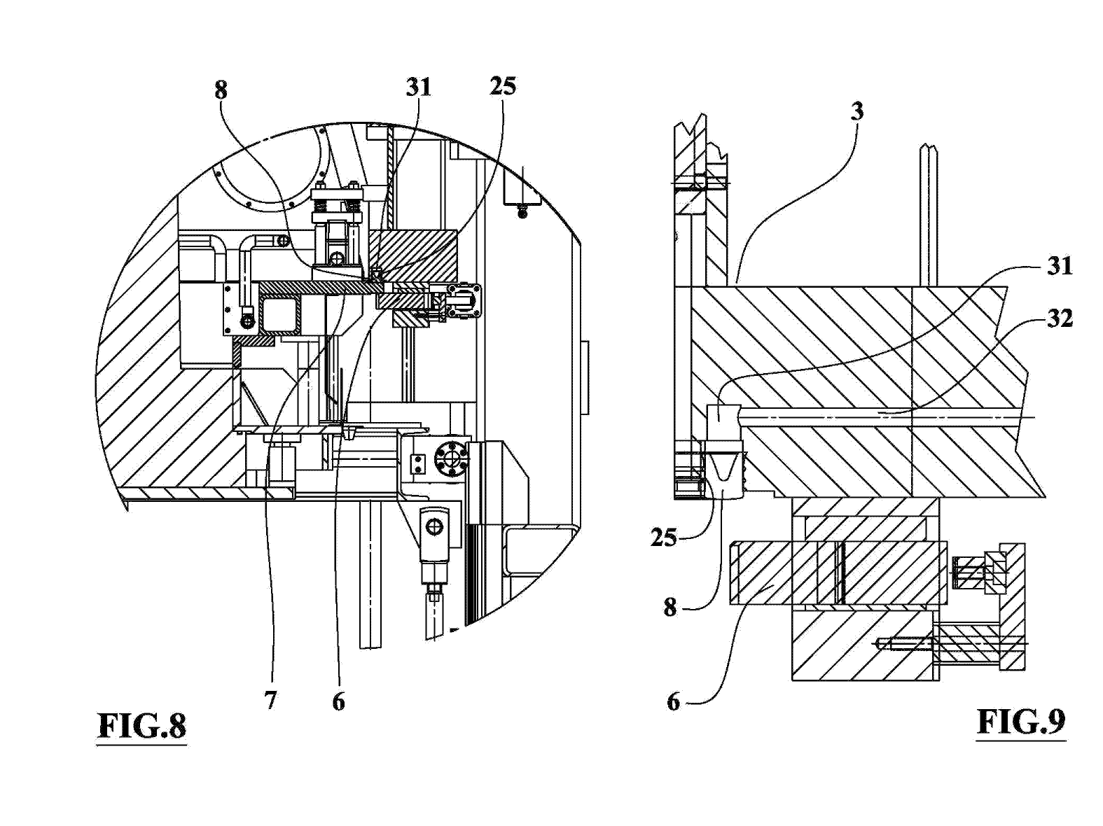

With reference to FIGS. 1-9, a device 1 is used for thermoforming plastic plates made from a thermoplastic material, for example ABS or HIPS, which is the object of the present invention.

In the following, reference is made to the vertical orientation of the device 1 when the device 1 is in its operating condition, in which the device is supported by a horizontal floor. The expressions, “top”, “bottom”, “upper”, “lower”, “vertical” and “horizontal” refer to this orientation and operating condition.

The device 1 has a bell 3, in which pressure can be brought to negative values by a suction device and to positive values by a pressurization device. A first upper frame 4 supports the bell 3 and is vertically movable by the use of respective actuators.

The first upper frame 4 is provided with a lock 6 for removably fixing of a first framework 7, usually placed in an upper portion of the device, lying on a horizontal plane and usually abutting with a lower opening of the bell, with a seal 8 interposed therebetween, which is used to prevent air from passing between the first frame 4 and the first framework 7.

The device 1 also has a second framework 9 located in a position horizontal and lower with respect to the first framework 7, which has a plan shape that is generally rectangular.

A conveyor of known type and not illustrated, for example of the pliers or chain type, translates the plasticized plates and places them between the first framework 7 and the second framework 9 that approach each other, by the use of vertical translational actuators. These tighten the interposed plate and thus close the mouth of the bell, inside which, thanks to the suction of air therefrom, forms a depressurized area, forming a “balloon” made as the plate is deformed and sucked into the bell 3.

A second frame 11, placed below the first upper frame 4 and below the first and second framework 7, 9, supports a forming mold 13, and by the use of actuators, places the forming mold 13 within the cavity formed by the balloon of the plate which is then made to stick to the mold thanks to a pressure difference between the inside and outside of the mold. The subsequent cooling of the plate stuck to the mold, concludes the forming of the plate.

The device 1 comprises a plurality of vertical cylinder shaped columns 15, each column having an upper end fixed to the first frame 4 and a lower end provided with a respective first connector 17 which is removably lockable to a corresponding second connector 18 fixed to the second frame 11. The locking occurs during forming of the plate.

Each first connector 17 is provided with a plurality of shoulders 20, 21 facing upwards and placed at a predetermined mutual distance. Each second connector 18 is provided, for each shoulder 20, 21, with at least one, preferably two, corresponding bolts 23, 24 which slide horizontally towards and away from a respective first connector 17.

Each bolt 23, 24 is provided with a respective matching surface 26, 27 facing downwards, each bolt being translated by a corresponding actuator to abut alternately with a respective shoulder 20, 21.

The matching surfaces 26, 27 are placed at a mutual distance equal to a predetermined mutual distance between the shoulders 20, 21 to which was subtracted or added a predetermined length of distance adjustment (or setting distance) between the first frame 4 and second frame 11. Typically the first connector 17 and the second connector 18 will be mutually fixed in a first position corresponding to a normal position of the first frame 4 when locked to the second frame 11 and alternatively the first and second connectors 17, 18 can be mutually fixed in a second position corresponding to an increased distance, for example, of 4 mm with respect to the normal distance between the first frame 4 and the second frame 11 when mutually locked. The second and increased distance allows, for example, the use of an upper framework 7 with increased height.

The shoulders 20, 21 consist of upper, horizontal and annular surfaces, being respective annular extensions or annular flanges made or secured to the lower ends of the columns 15.

The matching surfaces 26, 27 are annular horizontal sectors forming an integral part of the bolts 23, 24 which are, for example, in the form of a sector of a toroidal element.

Each bolt 23, 24 is actuated by a respective actuator 29 of the pneumatic cylinder type with a stem radially oriented with respect to a longitudinal axis of the corresponding column 15 and being fixed to a median portion of the bolt 23, 24.

As seen in the figures, there are two shoulders 20, 21 and four bolts 23, 24, but it is expected that such quantities can be multiplied by integers so as to obtain proportional increases in the possible reciprocal positions of the first frame 4 and the second frame 11 when these are mutually fixed.

In other words, taking in consideration the device of the figures having two shoulders 20, 21 and two pairs of matching surfaces 26, 27, the first shoulder 20 is spaced from the second shoulder 21 by a first distance and the pair of first matching surfaces 26 are spaced from the pair of second matching surfaces 27 by a second distance. The modulus, or absolute value, of the difference between the first and second distances is equal to the adjustment lengths between the first frame 4 and the second frame 11.

As seen, the difference between the distance that separates the matching surfaces 26, 27 and the distance that separates the shoulders 20, 21, corresponds to a thickness adjustment of about 4 mm, but such an adjustment can be easily adapted to account for various needs.

The mouth of the bell 3 inferiorly bears an annular housing 25 consisting of a milled groove which is configured to house a seal 8 made of a solid or closed cell elastomeric material and having almost constant volume.

The bottom of the annular housing 25 has a channel 31, for example consisting of a further and smaller groove, for receiving a pressurized fluid fed through at least one supply duct 32 in flow communication with a pressurized fluid source. Such a fluid transmits to the seal a homogeneous pressure for biasing the seal to an outside of the annular seat.

The cross sections of the annular housing 25 and the seal 8 are approximately rectangular and show, respectively, a depth and a height so as to enable the almost total entry of the seal within the annular housing and the protrusion of the seal outward from the annular housing.

The seal 8 has an annular shape and has a portion protruding from the seat which is flat or rounded and configured to abut with a top flat face of a peripheral flange of the first framework 7.

The lower face of the peripheral flange of the first framework 7 is configured to abut with the lock 6.

The seal 8 has sides which bear respective longitudinal protrusions configured to statically or slidably abut with the sides of the annular housing 25.

The portion of the seal 8 facing the bottom of the annular housing 25 bears two longitudinal divergent winglets. Such protrusions and longitudinal winglets improve the sealing of the pressurized fluid between the seal 8 and the annular housing 25 by the external extroversion of the winglets caused by the pressurized fluid acting on the inner surface of the winglets themselves.

The operation of the device, thanks to the synergy that develops between the system of adjustable mutual locking of the first frame 4 and the second frame 11, and the particular adaptive configuration of the seal 8, guarantees the perfect pneumatic seal of the bell even in the presence of stresses caused by irregularities and different tolerances, or to the use of plates with different and irregular thicknesses or by inhomogeneity of the forces applied by the actuators. In addition, the invention allows for even using upper frames with different thicknesses.

Furthermore, the invention advantageously avoids breaking the seal 8 because of pinching by the frame, avoiding also a consequent loss of its sealing function.

An advantage of the present invention is to provide a device able to locate the upper and lower frames at two or more predefined and predetermined mutual distances.

Another advantage is to provide a device having a seal able to compensate for variations or irregularities of the distance between the mouth of the bell, in dynamic way.

A further advantage consists in the possibility of thermoforming with pressure equal to or greater than two bars inside the bell, without the need of having to press against one another the two upper and lower frames.

Another advantage consists in the possibility to fit in the machine and use also upper frames which are deformed or out of normal tolerances without compromising the operation and productivity of the device.

A further advantage consists in the fact that any “pinching” of the seal does not compromise the functionality since this would not cause the seal to break.

1. A device for thermoforming plastic plates comprising:
a bell,
an upper first frame supporting the bell and equipped with a lock for removably fixing an upper first framework abutting on a lower opening of the bell, with a seal interposed therebetween;
a second frame located below the first frame and the first framework, for supporting a forming mold for forming the plastic plates;
a plurality of vertical columns, each column having a top end fixed to the first frame and a lower end provided with a first connector removably lockable to a corresponding second connector fixed to the second frame;
each first connector being equipped with a plurality of shoulders upwardly oriented and sited at a predetermined mutual distance;
each second connector being provided with at least one corresponding bolt per each shoulder, each bolt having a respective matching surface downwardly facing and each bolt being movable by a corresponding actuator for alternatively matching with a respective shoulder, a distance between adjacent shoulders being different from a distance between adjacent matching surfaces.

2. The device according to claim 1 wherein each shoulder consists of horizontal annular shaped surface forming an annular protrusion or annular flange positioned on a lower end of a respective column;
and wherein the matching surfaces consist of horizontal annular sectors of the bolts, the bolts having a toroidal sector shape.

3. The device according to claim 1 wherein each bolt is movable by a respective actuator consisting of a pneumatic cylinder whose stem is radially oriented with respect to a longitudinal axis of a corresponding column, said stem being fixed to a median portion of the respective bolt.

4. The device according to claim 1 wherein each first connector has two shoulders and each second connector has at least four bolts.

5. The device according to claim 4 wherein a distance between the matching surfaces, minus a distance between the shoulders, is about 4 mm.

6. The device according to claim 1 wherein a lower portion of a mouth of the bell has an annular housing configured to house the seal, the seal being made of a solid elastomeric material or of a closed cell foam material.

7. The device according to claim 6 wherein a bottom of the annular housing has a channel adapted for receiving a pressurized fluid fed from a feeding pipe which is in flow communication with a source of pressurized fluid.

8. The device according to claim 6 wherein a transverse section of the annular housing and of the seal are almost rectangular shaped and the annular housing has a respective depth and height to allow an almost complete entering of the seal into the annular housing, such that the seal at least partially protrudes outward from the annular housing.

9. The device according to claim 8 wherein the portion of the seal protruding outward from the housing is configured to match with an upper flat face of a perimetric flange of the first framework, the seal portion being flat or rounded; and wherein a lower face of the perimetric flange of the first framework is configured to match with the lock.

10. The device according to claim 6 wherein a side faces of the seal have respective longitudinal protrusions configured to match with sides of the annular housing, a portion of the seal facing a bottom of the annular housing having two diverging longitudinal winglets.

11. The device according to claim 1 wherein each first connector has two shoulders and each second connector has two bolts, a first shoulder being spaced from a second shoulder by a first distance and a first matching surface spaced from a second matching surface by a second distance; a modulus of a difference between said first and second differences being equal to an adjustment length between the first frame and the second frame.
